(19) United States
(12) Patent Application Publication
(10) Pub. No.: US 2026/0266636 A1
(43) Pub. Date: Sep. 10, 2026

(54) ATTACHMENT MEMBER AND SENSING DEVICE

(71) Applicant: THK CO., LTD., Tokyo (JP)

(72) Inventor: Masashi Sugiura, Tokyo (JP)

(73) Assignee: THK CO., LTD., Tokyo (JP)

(21) Appl. No.: 19/166,136

(22) PCT Filed: Mar. 12, 2024
(86) PCT No.: PCT/JP2024/009502

§ 371 Date: Sep. 17, 2025

(30) Foreign Application Priority Data
Mar. 22, 2023 (JP) 2023-045978

(51) Int. Cl. G01D 11/30

(52) U.S. Cl. CPC G01D 11/30; F16B 2200/83

(57) ABSTRACT

Provided is a member allowing an object to be attached to another object by using a magnet in a simple manner with small shock. An attachment member (1) in accordance with an aspect of this invention is to be attached to an end surface of a first object (100), the attachment member including: a magnet (10); and an elastic body (20), the attachment member being fixed to a second object (110) by a magnetic force of the magnet (10), the elastic body (20) protruding from a surface of the attachment member which surface is located closer to the second object (110) in a state where the attachment member is fixed to the second object (110).

### TECHNICAL FIELD

The present invention relates to an attachment member and a sensing device.

### BACKGROUND ART

There is a case where an object that is easily broken when subjected to shock is to be attached to a magnetic body such as a metal by using a magnetic force of a magnet. In this case, in order to prevent the object from being broken by shock applied thereto when the magnet adheres to the object, the attachment needs to be carried out while paying attention, e.g., by first putting only an end part of a surface-to-be-attached to an attachment surface and then carefully attaching the entire attachment surface.

Patent Literature 1 discloses a wall surface mounting member using a neodymium magnet.

### PATENT LITERATURE

### Patent Literature 1

Japanese Patent Application Publication, Tokukai, No. 2018-114008

### SUMMARY OF INVENTION

### Technical Problem

The above-described technique, however, does not include any means for alleviating shock generated when the attachment is carried out by using a magnetic force of the magnet. In carrying out the attachment by using the magnetic force of the magnet, the following problem may occur. That is, as the attachment is to be made firmer, a magnetic force required therefor becomes larger and accordingly shock given at the time of the attachment becomes larger, too.

An aspect of the present invention has an objective to provide a member that allows an object to be attached to another object by using a magnet in a simple manner with small shock.

### Solution to Problem

In order to attain the above objective, an attachment member in accordance with an aspect of the present invention is to be attached to an end surface of a first object, the attachment member including: a magnet; and an elastic body, the attachment member being fixed to a second object by a magnetic force of the magnet, the elastic body protruding from a surface of the attachment member which surface is located closer to the second object in a state where the attachment member is fixed to the second object.

In order to attain the above objective, a sensing device including a fixing part in accordance with an aspect of the present invention includes: a magnet; and an elastic body, the sensing device being fixed to another object by a magnetic force of the magnet, the elastic body protruding from a surface of the sensing device which surface is located closer to the another object in a state where the sensing device is fixed to the another object.

### Advantageous Effects of Invention

In accordance with an aspect of the present invention, it is possible to provide a member that allows an object to be attached to another object by using a magnet in a simple manner with small shock.

### BRIEF DESCRIPTION OF DRAWINGS

FIG. 1 is a view schematically illustrating a configuration of an attachment member in accordance with an embodiment of the present invention.

FIG. 2 is a view schematically illustrating a configuration of the attachment member in accordance with the embodiment of the present invention.

FIG. 3 is a view schematically illustrating a cross section of the attachment member in accordance with the embodiment of the present invention.

FIG. 4 is a view schematically illustrating a cross section of the attachment member in accordance with the embodiment of the present invention.

FIG. 5 is a view schematically illustrating a cross section of an attachment member in accordance with an embodiment of the present invention.

FIG. 6 is a view schematically illustrating a cross section of the attachment member in accordance with the embodiment of the present invention.

FIG. 7 is a view schematically illustrating a cross section of the attachment member in accordance with the embodiment of the present invention.

FIG. 8 is an enlarged view of a part of an attachment member in accordance with an embodiment of the present invention.

FIG. 9 illustrates (i) an attachment member in accordance with an embodiment of the present invention and (ii) a variation of the attachment member to be used for a test.

FIG. 10 illustrates a result of a test conducted on the attachment member in accordance with the embodiment of the present invention.

FIG. 11 illustrates a process of preparing to conduct the test on the attachment member in accordance with the embodiment of the present invention.

FIG. 12 illustrates a scene of the test on the attachment member in accordance with the embodiment of the present invention.

FIG. 13 illustrates a result of the test conducted on the attachment member in accordance with the embodiment of the present invention.

### DESCRIPTION OF EMBODIMENTS

### First Embodiment

### Configuration of Attachment Member

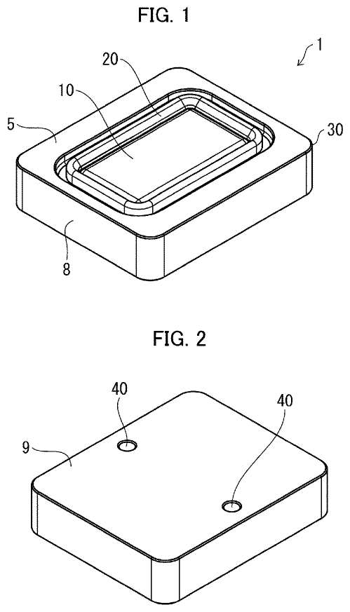

FIG. 1 is a view schematically illustrating an example of a configuration of an attachment member in accordance with the present embodiment. The attachment member 1 is a member that is to be attached to a certain object so as to fix the certain object to another object, which is a magnetic body. That is, the certain object is fixed to another object via the attachment member 1 attached to the certain object. FIG. 1 illustrates a configuration of a surface which serves as a fixing surface when the certain object is fixed, by a magnetic force of a magnet included in the attachment member 1, to another object that is the magnetic body in a state where the attachment member 1 is attached to an end surface of the certain object. In FIG. 1, an upper surface 5 of the attachment member 1 serves as the fixing surface.

The magnet refers to an object that applies a magnetic force to a magnetic body. A direction and a magnitude of the magnetic force are represented by a line of magnetic force. The line of magnetic force is a curved line drawn in a magnetic field in such a manner that a direction of a tangent line at each point is made coincide with a direction of the magnetic field at the position where the tangent line resides. Lines of magnetic force passing through a unit area perpendicular to the magnetic field are drawn such that the number of lines of magnetic force is in proportion to the strength of the magnetic field in the area. The magnetic body refers to an object that allows a line of magnetic force to pass therethrough. An elastic body refers to an object that is deformed in response to an external force applied thereto and generates a restoring force corresponding to the deformation. The restoring force refers to a force that acts to restore the elastic body having been elastically deformed to its original state.

In the present specification, the certain object having the end surface to which the attachment member 1 is attached will be referred to as a “first object”. Further, the attachment surface of the attachment member 1 which attachment surface is located closer to the first object in a state where the attachment member 1 is attached to the end surface of the first object will be referred to as a “first surface”. In FIG. 1, the first surface corresponds to a lower surface located so as to be opposed to the upper surface 5. Furthermore, another object to which the first object having the end surface to which the attachment member 1 is attached is fixed will be referred to as a “second object”. A surface of the attachment member 1 which surface is located closer to the second object and is used for the fixing will be referred to as a “second surface”. In FIG. 1, the second surface corresponds to the upper surface 5.

For example, the attachment member 1 includes a neodymium magnet 10 as a magnet. Further, for example, the attachment member 1 includes a damper rubber 20 as an elastic body disposed in an area surrounding the neodymium magnet 10. Moreover, for example, the attachment member 1 includes a yoke 30 as a magnetic body disposed in an area surrounding the damper rubber 20. The neodymium magnet 10 and the damper rubber 20 may be closely adhered to each other. Further, the damper rubber 20 and the yoke 30 may be closely adhered to each other.

As the damper rubber 20, nitrile butadiene rubber (NBR) may be used. As the yoke 30, stainless steel (SUS; steel use stainless) may be used.

Particularly, various kinds of rubbers are manufactured; therefore, if a rubber is selected as the elastic body, it will be easy to select a rubber suitable for a detailed objective and a purpose of using the attachment member 1.

Instead of the configuration illustrated in FIG. 1, a neodymium magnet 10 and a damper rubber 20 may be provided to one or more of the upper surface 5 and four side surfaces 8 of the attachment member 1 shown in FIG. 1 in a similar manner to that of the upper surface 5 shown in FIG. 1. In this case, the one or more of the surfaces, each having the similar configuration of the upper surface 5 shown in FIG. 1, of the attachment member 1 is/are fixed to the second object by a magnetic force of the magnet(s). This means that the first surface, which is to face the first object, and the second surface, which is to face the second object, are not necessarily opposed to each other.

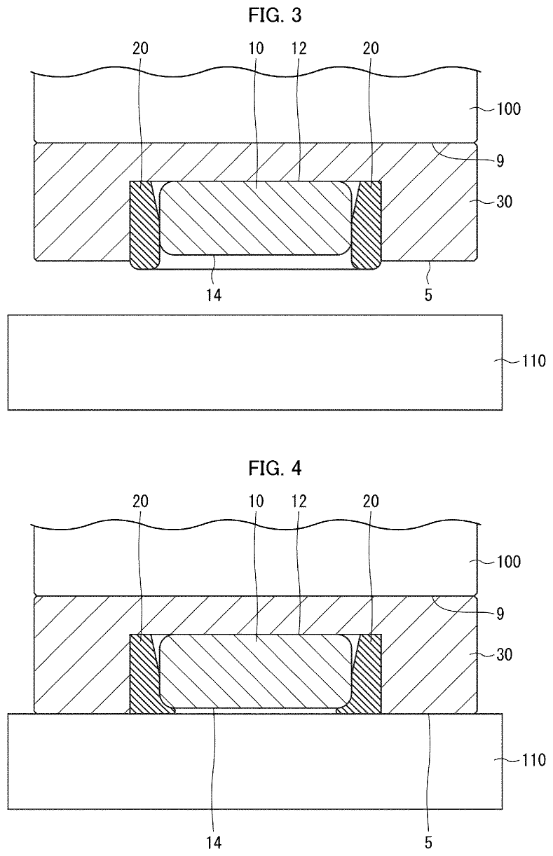

As illustrated in FIG. 1 and the later-described FIG. 3, the damper rubber 20 protrudes on the second surface side of the attachment member 1. With this, in fixing the first object to which the attachment member 1 is attached to the second object by a magnetic force of the neodymium magnet 10, the damper rubber 20 first comes into contact with the second object. As the neodymium magnet 10 gets closer to the second object, the magnetic force that the neodymium magnet 10 applies to the second object becomes larger. However, as the neodymium magnet 10 gets closer to the second object, deformation of the damper rubber 20 also becomes larger, and accordingly the restoring force becomes larger. Thus, shock generated at the time of the fixing is absorbed by the damper rubber 20. Therefore, for example, in a process of attachment of a precision device, it is not necessary to pay attention by, e.g., first putting only an end part of a surface-to-be-attached of the precision device to a surface which is to be subjected to the attachment and then carefully pressing the entire surface-to-be-attached to that surface.

FIG. 2 is a view schematically illustrating an example of a configuration of the first surface 9 of the attachment member 1 in accordance with the present embodiment. FIG. 2 illustrates, as an example, two screw holes 40 that are used to attach the attachment member 1 to the first object by screws. Instead of the illustrated configuration, the first surface 9 of the attachment member 1 may have the same configuration as that of the second surface of the attachment member 1 shown in FIG. 1, for example. In this case, the attachment member 1 is attached to the end surface of the first object by a magnetic force, and thus the first object needs to be a magnetic body.

FIG. 3 is a view schematically illustrating the damper rubber 20 which is not deformed yet, observed while the attachment member 1 is being fixed to a second object 110 by a magnetic force of the [symbol] : 10 neodymium magnet 10 with the attachment member 1 being attached to an end surface of the first object 100.

FIG. 4 is a view schematically illustrating the damper rubber 20 which has been deformed, observed while the first object 100 is being fixed to the second object 110 by a magnetic force of the neodymium magnet 10 with the attachment member 1 being attached to the end surface of the first object 100.

When the attachment member 1 is fixed to the second object 110, the damper rubber 20 is pressed and accordingly its thickness in a direction extending from the first surface 9 to the second surface 5 is reduced. The rubber is a substantially complete incompressible material (i.e., a material having a volume that would not be changed even when subjected to an external force), and thus the damper rubber 20 is to be enlarged in a direction other than the above direction. Consequently, in a case where there is a gap between the neodymium magnet 10 and the second object 110 as shown in FIG. 4, the damper rubber 20 is deformed so that the damper rubber 20 enters the gap. Meanwhile, there may be a case where there is no gap between the neodymium magnet 10 and the second object 110 or a case where another space in which the damper rubber 20 is allowed to be enlarged is insufficient. In this case, the thickness of the damper rubber 20 in the direction extending from the first surface 9 to the second surface 5 is still larger than a thickness of the neodymium magnet 10 in the direction extending from the first surface 9 to the second surface 5. In such a state, a surface of the yoke 30 which surface is located closer to the second surface 5 cannot be entirely in contact with the second surface 5. Consequently, an [symbol] 11 absorbing force of the attachment member 1 with respect to the second object 110 is weak.

The following will study a case where elements such as (i) the thicknesses of the damper rubber 20 and the yoke 30 in the direction extending from the first surface 9 to the second surface 5 and (ii) the space in which the damper rubber 20 is allowed to be enlarged are determined so as to allow the surface of the yoke 30 which surface is located closer to the second surface 5 to be entirely in contact with the second surface 5. Even in this case, as long as the damper rubber 20 is pressed and accordingly its thickness in the direction extending from the first surface 9 to the second surface 5 is reduced when the first object 100 is fixed to the second object 110, the restoring force of the damper rubber 20 acts in a direction resisting the magnetic force of the neodymium magnet 10. However, in a case where a difference between the above thicknesses and the space in which the damper rubber 20 is allowed to be enlarged are appropriate, the damper rubber 20 and the yoke 30 are fixed to the second object 110 on the same flat plane.

Consequently, a line of magnetic force generated from a surface 12 (an S pole or an N pole of the neodymium magnet 10) of the neodymium magnet 10 which surface 12 is in contact with the yoke 30 passes through the yoke 30 and then flows into the second object. As a result, a magnetic circuit between the yoke 30 and the second object is closed. Here, the magnetic circuit refers to a path through which the line of magnetic force passes. Closing the magnetic circuit strengthens an absorbing force caused by a magnetic force of the neodymium magnet 10 acting between the yoke 30 and the second object.

On the second surface fixed to the second object, the damper rubber 20 is closely adhered to the second object by the restoring force. Thus, even in a case where a liquid exits in an area outside the attachment member 1, it is possible to prevent or reduce ingress of the liquid into the damper rubber 20. This liquid ingress prevention effect becomes particularly large when the attachment member 1 is fixed to the second object and the damper rubber 20 completely covers a circumference of the neodymium magnet 10 on the fixing surface. Even in a case where the damper rubber 20 does not completely cover the circumference of the neodymium magnet 10, it is possible to prevent or reduce ingress of the liquid through a part where the damper rubber 20 resides. The liquid ingress prevention effect with respect to the neodymium magnet 10 is a combination of the effect given by the damper rubber 20 and the effect given by the yoke 30.

The yoke 30 is made of a material that would not be deformed even when subjected to vibrations after the fixing, and therefore it is possible to attain a wider frequency band with which vibrations of the second object can be accurately measured. This effect will be clearly understood, considering a case where the first object has a vibration measurement function and a surface of the attachment member which surface is configured to come into contact with the second object is entirely made of only a material such as a double-sided tape or a rubber. That is, in a case where only the material (e.g., the double-sided tape or the rubber) that is deformed when subjected to vibrations comes into contact with the second object, this will cause a reduction in resonance frequency. On the other hand, if the material that would not be deformed even when subjected to vibrations also comes into contact with the second object, this will provide the effect of suppressing the reduction in the resonance frequency.

The neodymium magnet 10 has an opposed surface that is opposed to the surface of the neodymium magnet 10 which surface is in contact with the yoke 30, and the opposed surface may or may not come into contact with the second object when the attachment member 1 is fixed to the second object. In a configuration in which the opposed surface of the neodymium magnet 10 comes into contact with the second object, the magnetic circuit passing through the yoke is completely closed; therefore, this configuration involves an advantage of providing firmer fixing. Meanwhile, a configuration in which the opposed surface of the neodymium magnet 10 does not come into contact with the second object involves an advantage of preventing or reducing abrasion of the surface of the neodymium magnet 10. In addition, with this configuration, shock generated when the attachment member 1 is fixed to the second object would not be directly applied to the neodymium magnet 10; therefore, this configuration involves an advantage of preventing or reducing the neodymium magnet 10 from being damaged by the shock.

The damper rubber 20 may be disposed so as to cover all of the surfaces of the neodymium magnet 10 other than the surface 12 that is in contact with the yoke 30 and a surface 14 that is opposed to the surface 12. In such arrangement, a line of magnetic force extending from a side of the neodymium magnet 10 which side is closer to the second surface 5 would not be shorted to the yoke 30, but extends to the second object. This strengthens the magnetic force acting between the side of the neodymium magnet 10 which side is closer to the second surface 5 and the second object. By utilizing this phenomenon, an area of the part of the damper rubber 20 which part covers the circumference of the neodymium magnet 10 may be adjusted so as to prevent a situation that the line of magnetic force extending from the side of the neodymium magnet 10 which side is closer to the second surface 5 is shorted to the yoke 30.

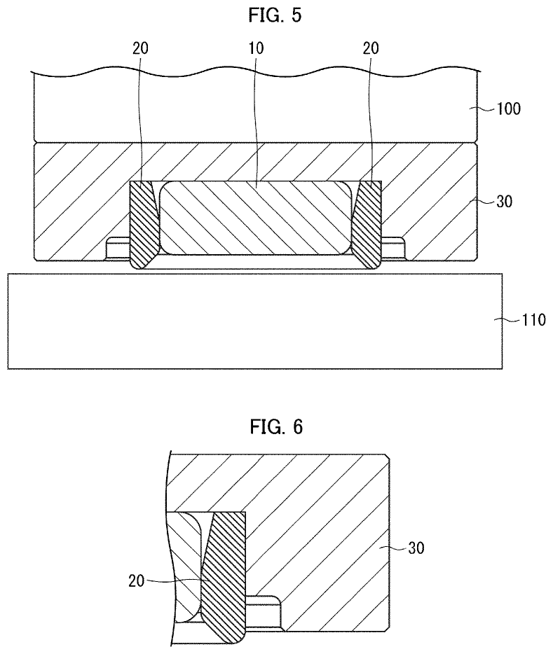

FIG. 5 illustrates an example of a configuration in which an end part of a damper rubber 20 protrudes more in a second surface with increasing proximity to the yoke 30 and with increasing distance from the neodymium magnet 10. The damper rubber 20 is formed in the above shape so that, when the attachment member 1 is fixed to the second surface, the end part of the damper rubber 20 is bent, on the second surface, in a direction opposite to a direction toward the neodymium magnet 10, that is, in a direction toward an outer edge of the damper rubber 20.

FIG. 6 is an enlarged view of the protrusion of the end part of the damper rubber 20 on the second surface, shown as an example. If the end part of the damper rubber 20 is bent, on the second surface, toward the neodymium magnet 10 and is then sandwiched between the neodymium magnet 10 and the second object when the attachment member 1 is fixed to the second object, the following problem may occur.

That is, even in a case where the neodymium magnet 10 is designed to be fixed to the second object in a state where the neodymium magnet 10 is in contact with the second object, the above phenomenon would prevent the neodymium magnet 10 from coming into contact with the second object. Meanwhile, also in a case where the neodymium magnet 10 is designed to be fixed to the second object in a state where the neodymium magnet 10 is distant from the second object, the above phenomenon would make the neodymium magnet 10 greatly distant from the second object. Moreover, the above phenomenon can prevent the yoke 30 from coming into contact the second object. Any of the above three cases would result in a reduction of a force for fixing to the second object by a magnetic force of the neodymium magnet 10.

If both of or one of the neodymium magnet 10 and the yoke 30 is designed to come into contact with the fixing surface but the neodymium magnet 10 and/or the yoke 30 does not actually come into contact with the fixing surface, another adverse effect would be given. That is, a friction force against an external force acting to move the attachment member 1 fixed to the fixing surface is made smaller, and consequently the attachment member 1 is likely to be moved by the external force.

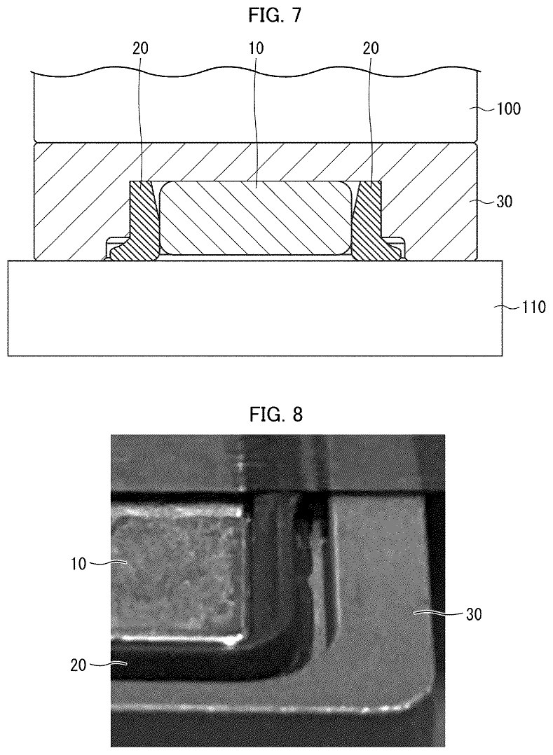

FIG. 7 illustrates an example of a state where fixing of the attachment member 1 configured as illustrated in FIG. 5 to the second surface has been done. The end part of the damper rubber 20 is bent, on the second surface, in the direction opposite to the direction toward the neodymium magnet 10, that is, in the direction toward the outer edge of the damper rubber 20.

As illustrated in FIG. 7, the yoke 30 may have a groove for housing the end part of the damper rubber 20 which end part is bent, on the second surface, in the direction opposite to the direction toward the neodymium magnet 10. When the end part is housed in the groove, the yoke 30 comes into contact with the second object, and consequently a magnetic circuit between the yoke 30 and the second object is closed, in a similar manner to that explained above. The surface of the neodymium magnet 10 which surface is located closer to the second surface may or may not come into contact with the second object when the attachment member 1 is fixed to the second object, in a similar manner to that explained above.

The following will compare (i) a case where the groove has enough space to house the end part with (ii) a case where the groove is not provided as illustrated in FIG. 4 and the damper rubber 20 not provided with the above-described end part is deformed so as to enter a gap between the neodymium magnet 10 and the second object 110 and/or the like. In conclusion, the former configuration in which the damper rubber 20 has the end part shaped in the above-described manner and there is enough space to house the end part makes the damper rubber 20 exert a smaller restoring force for making the first object 100 and the second object 110 away from each other. Therefore, the former configuration fixes the attachment member 1 to the second object more firmly.

Furthermore, when the end part is housed in the groove, the liquid ingress prevention effect given by the damper rubber 20 becomes even larger. This happens because of an increase in an area of a part of the fixing surface in which part the damper rubber 20 is closely adhered to the second object. The above-described liquid ingress prevention effect becomes particularly large in a case where the damper rubber 20 completely covers the circumference of the neodymium magnet 10 on the fixing surface when the attachment member 1 is fixed to the second object. Even in a case where the damper rubber 20 does not completely cover the circumference of the neodymium magnet 10, it is possible to prevent or reduce ingress of the liquid through a part where the damper rubber 20 resides. The liquid ingress prevention effect with respect to the neodymium magnet 10 is a combination of the effect given by the damper rubber 20 and the effect given by the yoke 30.

FIG. 8 illustrates an image of an example of a prototype of the attachment member 1. When seen from a second surface of a yoke 30 as a reference, an end part of a damper rubber 20 protrudes more with increasing proximity to an outer edge of the second surface.

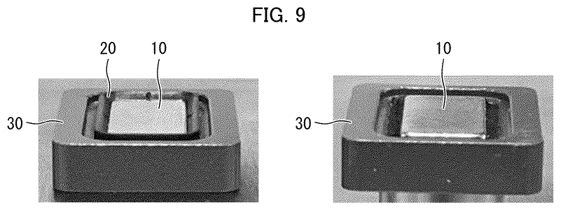

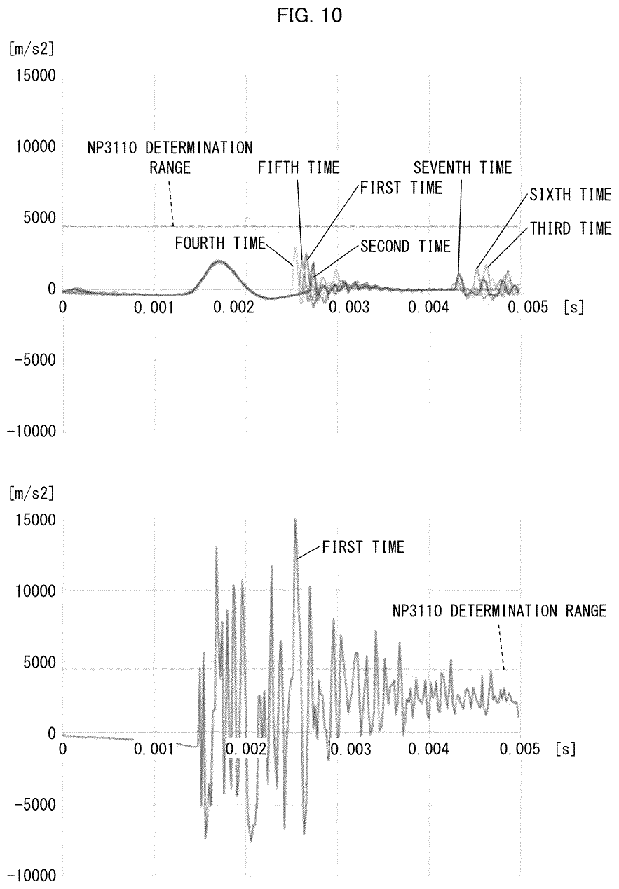

Each of FIGS. 9 and 10 is a view illustrating an example of a test for measuring a difference between (i) an acceleration generated when the first object is fixed to the second object in the configuration with the damper rubber 20 and (ii) an acceleration generated when the first object is fixed to the second object in the configuration without the damper rubber 20.

The left side of FIG. 9 shows an image of a prototype of the attachment member 1 including the damper rubber 20, which has been discussed so far. The right side of FIG. 9 shows an image of a prototype which is identical to the above attachment member 1 except for the point that the prototype on the right side does not include the damper rubber 20. Either of the prototypes were configured such that, when the attachment member 1 absorbs the second object, the yoke 30 comes into contact with the second object but neodymium magnet 10 does not come into contact with the second object.

In the measurement test, the above-described two prototypes were prepared. In each of the two prototypes, a plate (shim) having a thickness of 1 mm was fixed by being sandwiched between the yoke 30 and the second object; and thereafter the shim was pulled out. In this manner, for each of the two prototypes, an acceleration at which the prototype came into contact with the second object by an absorbing force of the neodymium magnet 10 was measured. The measurement was carried out by using, as the first object, an acceleration pickup device. By using the acceleration pickup device, it is possible to obtain a vibration amount of a machine system as an electric signal that is in proportion to an acceleration.

FIG. 10 illustrates a result of the measurement test. The upper graph illustrates a result given by the prototype with the damper rubber 20, whereas the lower graph illustrates a result given by the prototype without the damper rubber 20. In each of these graphs, the vertical axis indicates an acceleration, and the horizontal axis indicates time.

The upper graph indicates a result given when a similar test was repeatedly carried out seven times. A peak observed in a period from a point of time 0.0014 [s] to a point of time 0.002 [s] indicates an acceleration observed when the damper rubber 20 came into contact with the second object. Peaks observed in a period from a point of time 0.0025 [s] to a point of time 0.003 [s] indicate accelerations observed when the yoke 30 came into contact with the second object.

The lower graph indicates a result given when the test was carried out only once. At points of time after a point of time 0.0014 [s], acceleration values changed more greatly in comparison to those in the upper graph. These changes correspond to vibrations generated after the yoke 30 came into contact with the second object. In the lower graph, the changes in the acceleration values exceeded a measurement range of the acceleration pickup device, which was used as the first object. Thus, acceleration values above the measurement range may not be accurate, and are values merely for reference.

In the upper graph, two major peaks of the accelerations are both smaller than the peaks in the lower graph.

The above has demonstrated that the damper rubber 20 has a shock absorbing effect.

In addition to the above configuration, the damper rubber 20 may have a function to prevent or reduce ingress of a liquid. The damper rubber 20 having the above function may be configured to completely cover the circumference of the neodymium magnet 10 on the second surface fixed to the second object.

On the second surface fixed to the second object, the damper rubber 20 is closely adhered to the second object by the restoring force. Therefore, one of or both of (i) the above function and (ii) the configuration in which the damper rubber 20 completely covers the circumference of the neodymium magnet 10 further increases the above-described ingress prevention effect of preventing or reducing ingress of a liquid existing in the area outside the attachment member 1 into the damper rubber 20.

In the configuration in which the end part of the damper rubber 20 protrudes more on the second surface with increasing proximity to the yoke 30 and the protrusion is housed in the groove in the fixing surface, the liquid ingress prevention effect becomes even larger. This happens because of an increase in an area of a part of the fixing surface in which part the damper rubber 20 is closely adhered to the fixing surface.

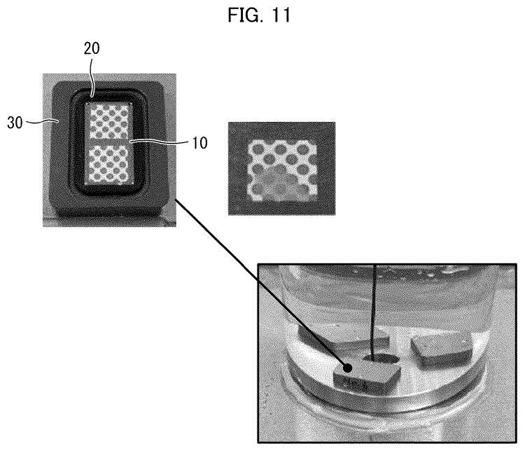

Each of FIGS. 11, 12, and 13 illustrates a demonstration test for demonstrating the effect of the damper rubber 20 for preventing or reducing ingress of the liquid.

FIG. 11 illustrates a state in which a sticker that irreversibly changes its color when water touches the sticker was bonded to a surface of a neodymium magnet 10 which surface was disposed closer to a second surface of an attachment member 1. FIG. 11 also illustrates a state in which the color of the sticker had been changed irreversibly due to water touching the sticker. Further, FIG. 11 also illustrates a state in which the attachment member 1 having the sticker bonded thereto was absorbed, by a magnetic force of the neodymium magnet 10, to a plate that was a magnetic body.

The number of attachment members 1 each including a neodymium magnet 10 having the above-described sticker bonded thereto was three in total. The three attachment members 1 were identified by respective numbers given thereto, specifically, No. 5, No. 6, and No. 7.

FIG. 11 also illustrates a subsequent state in which the plate having the three attachment members 1 attached thereto was submerged in water.

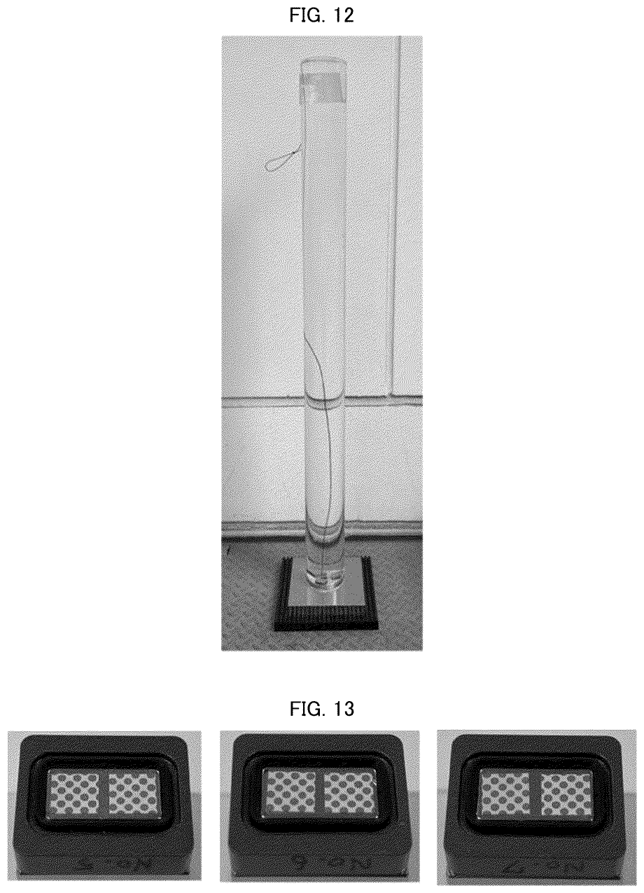

FIG. 12 illustrates a state in which the plate having the three attachment members 1 attached thereto was submerged at a depth of 1 m. In this demonstration test, the plate was left for 30 minutes in the state where the plate was submerged in the water (as shown in FIG. 12). This is a water ingress protection test equivalent to IPx7 (the waterproof and dustproof standards defined by the International Electrotechnical Commission (IEC)).

FIG. 13 illustrates a state in which, after lapse of 30 minutes that was the time period for leaving, the plate having the attachment members 1 including the three neodymium magnets 10 attached thereto were taken out from the water, the water on the surface of the plate were wiped off, and then the attachment members 1 were separated from the plate.

None of the stickers bonded to the three neodymium magnets 10 did not exhibit any change in color. This demonstrates that the damper rubber 20 has the liquid ingress prevention effect.

Note that an adhesive may be applied to a surface of the neodymium magnet 10 disposed on the second surface of the attachment member 1 and then the neodymium magnet 10 may be fixed to the second object. The attachment member 1 is designed such that the neodymium magnet 10 to which an adhesive is applied is brought into contact with the second object so as to be fixed thereto. With such a configuration, even in a case where an adhesive whose adhesion effect is reduced when the adhesive comes in contact with a liquid is used, the adhesion effect would be maintained, thanks to the liquid ingress prevention effect of the damper rubber 20.

### Second Embodiment

### Object with Fixing Part

The attachment member 1 may not be independently manufactured and commercially distributed assuming that the attachment member 1 is to be attached to an end surface of an object. Alternatively, the features of the attachment member 1 may be manufactured such that these features are included in the object as a fixing part, which is a part of the object.

Examples of the object including, as the fixing part which is a part of the object, the features of the attachment member 1 include a sensor (sensing device) that is to be attached to, e.g., a guide block included in a motion guide device and that is configured to sense an acceleration and/or the like. In a case where the sensor includes, as the fixing part which is a part of the sensor, the features of the attachment member 1, an effect of eliminating the need to attach the attachment member 1 to an end part of the sensor can be attained, in addition to the effects of the above-discussed attachment member 1. Further, by forming the attachment member 1 and the sensor in an integrated manner, it is expected that the fixing part will be less likely to be separated from the sensor including the fixing part, in comparison to the configuration in which the attachment member 1 is attached to the end part of the sensor.

Aspects of the present invention can also be expressed as follows:

An attachment member (1) in accordance with a first aspect of the present invention is an attachment member that is to be attached to an end surface of a first object (100), the attachment member including: a magnet (10); and an elastic body (20), the attachment member being fixed to a second object (110) by a magnetic force of the magnet, the elastic body protruding from a surface (5) of the attachment member which surface is located closer to the second object in a state where the attachment member is fixed to the second object.

An attachment member in accordance with a second aspect of the present invention may be configured such that, in the first aspect, the attachment member further includes: a magnetic body (30) in an area surrounding one of or both of the magnet and the elastic body.

An attachment member in accordance with a third aspect of the present invention may be configured such that: a thickness of the attachment member which thickness is up to, among end surfaces of the elastic body, a surface farthest from the end surface of the first object is larger than a thickness of the attachment member which thickness is up to, among end surfaces of the magnetic body, a surface farthest from the end surface of the first object and a thickness of the attachment member which thickness is up to, among end surfaces of the magnet, a surface farthest from the end surface of the first object.

An attachment member in accordance with a fourth aspect of the present invention may be configured such that: in a state where the first object is fixed to the second object by a magnetic force of the magnet, (a) a thickness of the elastic body in a direction extending from the end surface of the first object to a fixing surface in which the elastic body is fixed to the second object is reduced and (b) the elastic body and the magnetic body are fixed to the second object on a same flat plane.

An attachment member in accordance with a fifth aspect of the present invention may be configured such that: a thickness of the elastic body increases with increasing proximity to an outer edge of the elastic body on the surface of the elastic body which surface is farthest from the end surface of the first object, as seen from, among the end surfaces of the magnetic body, the surface farthest from the end surface of the first object as a reference; and a groove is provided in an area surrounding the outer edge of the elastic body.

An attachment member in accordance with a sixth aspect of the present invention may be configured such that, in the fourth or fifth aspect, the elastic body has a function to prevent or reduce ingress of a liquid.

An attachment member in accordance with a seventh aspect of the present invention may be configured such that, in any one of the first to sixth aspects, the elastic body is a rubber.

A sensing device in accordance with an eighth aspect of the present invention includes: a magnet; and an elastic body, the sensing device being fixed to another object by a magnetic force of the magnet, the elastic body protruding from a surface of the sensing device which surface is located closer to the another object in a state where the sensing device is fixed to the another object.

### REFERENCE SIGNS LIST

1: attachment member
10: neodymium magnet (magnet)
20: damper rubber (elastic body)
30: yoke (magnetic body)
100: first object
110: second object

1. An attachment member that is to be attached to an end surface of a first object, the attachment member comprising:
a magnet; and
an elastic body, the attachment member being fixed to a second object by a magnetic force of the magnet, the elastic body protruding from a surface of the attachment member which surface is located closer to the second object in a state where the attachment member is fixed to the second object.

2. The attachment member according to claim 1, further comprising:
a magnetic body in an area surrounding one of or both of the magnet and the elastic body.

3. The attachment member according to claim 2, wherein:
a thickness of the attachment member which thickness is up to, among end surfaces of the elastic body, a surface farthest from the end surface of the first object is larger than (1) a thickness of the attachment member which thickness is up to, among end surfaces of the magnetic body, a surface farthest from the end surface of the first object and (2) a thickness of the attachment member which thickness is up to, among end surfaces of the magnet, a surface farthest from the end surface of the first object.

4. The attachment member according to claim 3, wherein:
in a state where the first object is fixed to the second object by a magnetic force of the magnet, (a) a thickness of the elastic body in a direction extending from the end surface of the first object to a fixing surface in which the elastic body is fixed to the second object is reduced and (b) the elastic body and the magnetic body are fixed to the second object on a same flat plane.

5. The attachment member according to claim 4, wherein:
a thickness of the elastic body increases with increasing proximity to an outer edge of the elastic body on the surface of the elastic body which surface is farthest from the end surface of the first object, as seen from, among the end surfaces of the magnetic body, the surface farthest from the end surface of the first object as a reference; and
a groove is provided in an area surrounding the outer edge of the elastic body.

6. The attachment member according to claim 4, wherein:
the elastic body has a function to prevent or reduce ingress of a liquid.

7. The attachment member according to claim 5, wherein:
the elastic body has a function to prevent or reduce ingress of a liquid.

8. The attachment member according to claim 1, wherein:
the elastic body is a rubber.

9. A sensing device comprising:
a magnet; and
an elastic body,
the sensing device being fixed to another object by a magnetic force of the magnet,
the elastic body protruding from a surface of the sensing device which surface is located closer to the another object in a state where the sensing device is fixed to the another object.
